(19) United States
(12) Patent Application Publication
(10) Pub. No.: US 2002/0092922 A1
(43) Pub. Date: Jul. 18, 2002

(54) Spraying method and a spray system for coating liquids

(76) Inventor: Ronald Steiger, Gross-Zimmern (DE)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 10/042,394

(22) Filed: Jan. 11, 2002

(30) Foreign Application Priority Data
Jan. 13, 2001 (DE) 101 01 372.8

(51) Int. Cl. B05C 1/00

(52) U.S. Cl. 239/128

(57) ABSTRACT

The invention relates to a spraying method and to a spray system which comprises a unit (16) metering accessory liquid into the coating-liquid's spray jet (14).

The present invention relates to a spraying method and a spray system defined in the preamble of claims 1 and 9 resp.

Spray equipment comprising a rotary atomizer in the form of a so-called bell to atomize and spray coating liquids onto an object to be coated are known from the U.S. Pat. Nos. 4,275,383 and 4,505,430; German patent documents 30 00 002 A1 and 35 09 874 A1. They disclose applying a high electrical potential, which may be positive or negative, to the rotary atomizers and/or to the spray coating liquid. Typically the high voltage is in the range of 4 kv to 140 kv. A high-voltage spray system fitted with an irrotational spray nozzle is known from U.S. Pat. No. 3,731,145.

Rotary atomizing elements conventionally assume a bell shape or a disk form and may rotate at speeds up to 60,000 rpm.

The coating liquid may contain solvents or it may be a water-dilutable liquid, in particular paint, colored or clear lacquers/enamels.

The various kinds of coating liquids exhibit different viscosities and different drying rates. The liquid particles in the spray jet assume different shapes, sizes and flight properties on their way from the liquid atomizer to the object to be coated.

The high voltage generates an electric field between the spray system and an electrically conducting, grounded object to be coated. In this manner spray-jet scattering losses are reduced and higher coating rates and better coating qualities are attained. The adhesion of the liquid particles to the object to be coated depend on the kind of coating liquid and the electrostatic field.

The objective of the invention is to control in simple and economical manner the efficiency of coating and the quality of coating.

This objective is attained in the invention by the features of claims 1 and 9 resp.

Accordingly the present invention concerns a coating-liquid spraying method wherein coating liquid is sprayed from a spray system through a liquid atomizer in the form of an irrotational nozzle or in the form of a rotating rotary atomizing element onto an object to be coated, said method being characterized in that an accessory liquid is fed in metered manner into the coating liquid's spray jet and thereby it controls the micro-climate in the spray jet.

Moreover the invention relates to a coating-liquid spray system containing a liquid atomizer in the form of an irrotational nozzle or in the form of a rotating rotary atomizing element to spray coating liquid onto an object to be coated, said spray system being characterized in that it includes a feed device of accessory liquid to feed coating material in metered manner into the coating liquid's spray jet.

On account of this metered feed of accessory liquid onto or into the coating liquid's spray jet, the “microclimate” in said spray jet and hence also the coating efficiency and the quality of coating may be controlled and matched to various practical requirements.

The “microclimate”in particular relates to the spray jet's moisture content and the ratio of the volatile ingredients to non-volatile ingredients in the spray jet. Illustratively the paint/pigment particles of coating liquids of low viscosities may be “thinned” by applying the accessory liquid and consequently they may then be better atomized in the spray jet and be also better charged electrostatically. Depending on the kind of accessory liquid, latter also affects the electrical current between the spray system's spray jet and the grounded object to be coated. The accessory liquid furthermore affects the fluidity ofthe coating liquid's liquid particles on the object to be coated.

In a particular embodiment of the invention, the coating liquid is cooled prior to its atomization in the spray system, for instance in the liquid atomizing element or upstream of it. As a result the viscosity and the rate of evaporation (drying) of the coating liquid shall be reduced. Therefore the microclimate also can be controlled and the efficiency and quality of coating also can be improved.

Water is appropriately used for water-dilutable coating liquids or solvents for coating liquids containing solvents.

Preferably the accessory liquid shall be fed into the starting zone of the spray jet before said jet has grown to its full diameter, namely by pointing the accessory-liquid feed into the spray jet's starting zone.

Especially good results shall be attained by feeding the accessory liquid by means of the accessory-liquid feeding device which is pointed at the spray jet to the front end or downstream of it in the vicinity of the liquid atomizer's front end to the spray jet.

Depending on the accessory liquid being fed onto or into the spray jet at only one spot on periphery or over a larger peripheral arc or over the entire periphery of the spray jet, the properties of this spray jet may be matched to different kinds of objects and to different kinds of coating liquids. This feature also allows taking into account whether the object surface to be coated is vertical or horizontal. Illustratively, there is danger as regards vertical or oblique object surfaces that the deposited coating liquid shall drain downward. A slitted nozzle completely or partly enclosing the spray-jet axis, or one or a plurality of round or polygonal apertures, in particular nozzle apertures configured about the spray-jet axis, may be configured at the spray system to implement discharge of the accessory liquid.

Just as in the state of the art, the spray system may be fitted with one or more of the following sources of compressed-air: shaping air, configured on the sprayjet and illustratively enclosing it like a bell and jointly flowing with it to shape it; bearing air supporting the rotary atomizing element and/or a turbine driving it; turbine air to drive the turbine; deceleration air to slow the turbine and the rotary atomizing element. One or more kinds of this air may be cooled in the manner of the invention and may be used as a coolant to cool the coating liquid in the spray system.

The invention is elucidated below in relation to the drawings and in relation to a preferred illustrative embodiment.

FIG. 1 schematically shows a sideview at the bottom and at the top a longitudinal section of a spray system of the invention,

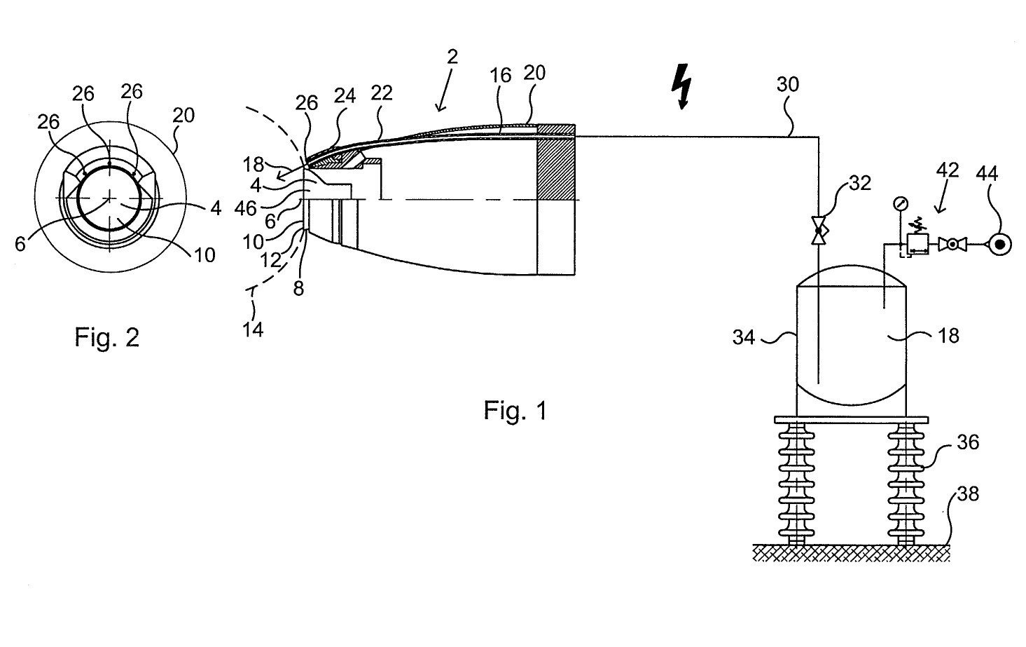

FIG. 2 schematically shows a front view from the left of the spray system of FIG. 1, and

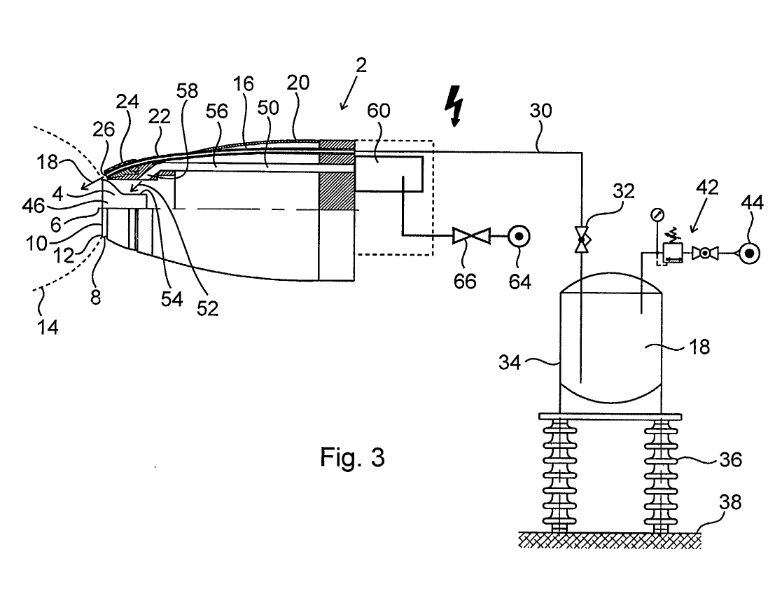

FIG. 3 schematically shows a sideview at the bottom and at the top a longitudinal section of a further embodiment of the spray system of the invention.

The coating-liquid spray system 2 of the invention shown in the drawings comprises a liquid atomizer in the form of a rotary atomizing element 4 driven by an omitted air turbine. Said element preferably shall be shall be an atomizing bell or pane rotating about an axis 6, further an external peripheral surface 8 and a front end surface 10. The end surface 10 assumes the shape of a bell (or saucer). Coating liquid issuing from the bell's edge 12—that is from the external periphery of the end surface 10 on account ofthe centrifugal force produced by the rotary atomizing element 4 in the form a forward pointing spray jet 14—flows radially from inside to outside on the said rotating end surface 10.

The rotary atomizing element 4 preferably shall be connected to a high voltage to generate a high electric field between it and the object to be coated.

A supply unit 16 to feed metered accessory liquid 18 onto and/or into the sprayjet 14 contains an accessory-liquid line 22 running on or through a spray-system housing 20 to a discharge element 24 mounted on or in said housing 20. The discharge element 24 is fitted with at least three discharge apertures 26 through which the accessory liquid 18 streams forward into the spray jet 14.

At the rear end of the housing 20, the accessory-liquid line 22 is connected by means of an external accessory-liquid feed line 30 containing a controlled valve 32 to a supply container 34 storing the accessory liquid 18. The voltage applied to the rotary atomizing element 4 also may be applied to the accessory liquid 18 which therefore rests by means of electrical insulators 36 on a subfloor 38.

A pump may be used to convey the accessory liquid to the discharge element 24. FIG. 1 shows another embodiment wherein a gas-pressure regulator 42 generates a gas pressure in the supply container 34, preferably the compressed air from a compressed-air source 34, by means of which accessory liquid 18 will be forced, when said valve 32 is open, out of the supply container 34 toward the discharge element 24 and from there into the spray jet 14.

Preferably the accessory liquid 18 shall be water provided the coating liquid of the spray jet 14 be water soluble. The accessory liquid preferably shall be a solvent when the coating liquid of the spray jet 14 contains solvents. The feed of accessory liquid into the spray jet 14 allows modifying and matching the viscosity of the spray mist or of the microclimate of the spray jet 14 with respect to different coating liquids.

The device feeding coating liquids to the rotary atomizing element 4 is omitted because known from the state of the art, for instance from U.S. Pat. Nos. 4,275,838 and 4,505,430.

The minimum of one discharge aperture 26 for accessory liquid 18 may be cross-sectionally circular or polygonal or a slit, illustratively it may be a slotted nozzle running over part or all the system periphery about the axis of rotation 6.

The accessory liquid 18 is metered toward the spray jet 14. The microclimate (moisture content, temperature, viscosity) in the liquid jet 14 can be controlled as a function of operational conditions, for instance the kind of coating liquid and the kind of object to be coated, while simultaneously the coating efficiency and quality are improved.

The accessory liquid 18 is fed to the starting zone of the liquid jet 14 before said jet attains its largest diameter. Preferably the accessory liquid 18 is fed directly at the front end of the liquid atomizer 4 to the spray jet 14.

The discharge aperture(s) 26 may be in the form of nozzle aperture(s) from which the accessory liquid 18 exits as a thick or as an atomizer jet.

The accessory liquid 18 either can be directly pointed from the minimum of one discharge aperture 26 into the spray jet 14, or in such a way that at least a portion of or all the accessory liquid 18 moves from the discharge apertures 26 onto the peripherally external terminal segment 46 of the rotary atomizing element 4 and is guided by said segment 46 into the spray jet 14. The feed element 16 for the accessory liquid 18, in particular the discharge apertures 26 and the feed pressure of the accessory liquid 18, either may be selected in such a way that the accessory liquid 18 issues from the discharge apertures 26 in the form of a liquid jet, or that the accessory liquid issues only drip-wise from the discharge apertures 26 and drips on the peripherally external terminal segment 46 of the rotary atomizing element 4. The rotation of the rotary atomizing element 4 generates a centrifugal force flinging the accessory liquid 18 from its external periphery's terminal zone 46 into the spray jet 14 of the coating liquid.

Spraying at least a portion of the accessory liquid 18 onto the external periphery's terminal segment 46 of the rotary atomizing element 4 offers a further advantage in that no coating liquid particles will deposit on said zone 46 where they might cure. Accordingly this terminal zone 46 of the external periphery will be kept clean.

The further embodiment of a spray system of the invention shown in FIG. 3 preferably also includes a cooling unit 50 to cool a system component in contact with the coating liquid on its way to the spray jet 14, said cooling being implemented in the present embodiment of the rotary atomizing element 4 by means of a fluid, cooled medium, during spray coating, in order to transmit the cold of the cooled coolant through the cold-conducting system component 4 to the spray coating liquid before latter is sprayed away. In the embodiment of FIG. 2, the coolant 52 is guided behind the terminal zone 46 of the external periphery onto the external peripheral surface 54, and the cold from the coolant 52 is transmitted by the rotary atomizing element 4, which is cold-conducting for instance being metallic, is transmitted to the coating liquid flowing through it which thereupon is sprayed as the spray jet 14.

The cooling unit 50 guides the coolant 52, which preferably is a cooled compressed gas, in particular cooled compressed air, inside a coolant line 56 to a coolant discharge 58 that points at the external peripheral surface 54 of the rotary atomizing element 4. The cold of the coolant passes through the rotary atomizing body 4 as far as its end surface 10 over which flows the coating liquid centrifuged by the rotating rotary atomizing body 4 and from which it is flung off at the outer edge of said element in the form of the spray jet 14.

A cooling unit 60 to cool the coolant 52 preferably shall be directly mounted on the spray system 2 or be integrated into it. In this way short paths are implemented for the coolant 52. The coolant 52 preferably shall be a compressed gas, for instance compressed air from a compressed-air source 64, and it is metered through a metering element 66 (for instance a valve) and it is guided through the coolant line 56 to the cooling unit 60 and cooled by latter and thereupon it is guided onto the rotary atomizing element 4. The cooling unit 60 may contain a so-called cooling gas cartridge to cool the coolant 52.

Cooling the rotary atomizing element by the coolant 52 offers the further advantage that it cools said element as far as into its terminal segment 46 of the external periphery. Sometimes coating-liquid particles migrating rearward out of the spray jet 14 will reach said terminal zone 46 of the external periphery. The lowered temperature assures that said coating-liquid particles will cure at substantially lower rates and adhere substantially less to the terminal zone 46 ofthe external periphery than at higher temperatures. Consequently less cleaning shall be required.

1. A method for spraying coating liquid, wherein coating liquid is sprayed from a spray system (2) through a liquid atomizer (4) in the form of an irrotational nozzle or in the form of a rotating rotary atomizing element onto an object to be coated
characterized in that the microclimate in said spray jet is controlled by an accessory liquid (18) being metered into the spray jet (14) of coating liquid.

2. Spraying method as claimed in claim 1, characterized in that the accessory liquid (18) is fed to the starting zone of the spray jet (14) before said spray attains its full diameter.

3. Spraying method as claimed in claim 2, characterized in that the accessory liquid (18) is fed from the front end of the liquid atomizer (4) or shortly downstream of it to the spray jet.

4. Spraying method as claimed in one of the above claims, characterized in that the accessory liquid (18) is fed in distributed manner over at least a portion of the periphery of the spray jet (14) to this spray jet.

5. Spraying method as claimed in one of the above claims, characterized in that at least a portion of the accessory liquid (18) is deposited on an externally peripheral terminal zone (46) of the liquid atomizer (4) and then is guided by said atomizer into the spray jet (14).

6. Spraying method as claimed in one of the above claims, characterized in that the accessory liquid (18) is fed through at least one nozzle aperture (26) which is configured at the front end segment of the spray system (2), in the form of an unbroken jet to the sprayjet (14).

7. Spraying method as claimed in one of the above claims, characterized in that the liquid atomizer (4) is a rotary atomizing element and in that the accessory liquid (18) is dripped onto the terminal zone (46) of the external periphery of the rotary atomizing element (4) and then is flung off said zone (46), on account of latter's centrifugal forces, into the spray jet (14).

8. Spraying method as claimed in one of the above claims, characterized in that a system component (4), which shall make contact the spray system with the coating liquid on its way to the spray jet (14), is cooled by a fluid and cooled coolant (52) and in that this cold of the coolant is transmitted through the cold conductivity of the system component (4) to the spray coating liquid.

9. A coating-liquid spray system containing a liquid atomizer (4) in the form of an irrotational nozzle or in the form of a rotating rotary atomizing element to spray the coating liquid onto an object to be coated,
characterized in that it comprises an accessory-liquid feed unit (16) fitted with at least one discharge (26) to meter the accessory liquid (18) into the coating-liquid's spray jet (14).

10. Spray system as claimed in claim 9, characterized in that the accessory-liquid's feed unit (16) is designed to feed the accessory liquid (18) into the initial zone of the spray jet (14) before said jet attains its maximum diameter.

11. Spray system as claimed in either of claims 9 and 10, characterized in that the accessory-liquid feed unit (16) is designed to feed the accessory liquid (18) into the spray jet (14) at the front end of the liquid atomizer (4).

12. Spray system as claimed in one of claims 9 through 11, characterized in that the accessory-liquid feed unit (16) is designed to feed the accessory liquid (18) distributed around the spray jet (14) into this jet.

13. Spray system as claimed in one of claims 9 through 12, characterized in that the accessory-liquid feed unit (16) is designed to deposit at least a portion of the accessory liquid (18) onto a front terminal zone (46) of the external periphery of the liquid atomizer (4) and then to guide said accessory liquid from said zone (46) into the spray jet (14).

14. Spray system as claimed in one of claims 9 through 13, characterized in that the minimum of one discharge (26) of the accessory liquid (18) is configured at the front terminal zone of the spray system (2).

15. Spray system as claimed in claim 14, characterized in that the liquid atomizer (4) is a rotary atomizing element and in that the accessory-liquid feed unit (16) is designed to drip the accessory liquid (18) onto the front terminal zone (46) ofthe external periphery of the rotary atomizing element and to fling the dripped accessory liquid (18) from the rotary atomizing element by means of latter's centrifugal forces into the spray jet.

16. Spray system as claimed in claim 14, characterized in that the accessory-liquid feed unit (16) inclusive its minimum of one discharge (26) is designed to deliver the accessory liquid (18) in the form of a continuous jet.

17. Spray system as claimed in one of the above claims, characterized in that it comprises a cooling unit (50) to cool at least one component (4) of the spray-system (2) by means of a fluid, cooled coolant (52), said system component (4) being in contact with the coating liquid on its way to the spray jet (14) and being cold-conducting in order to transmit cold from the coolant (52) onto the spray-coating liquid.

18. Spray system as claimed in claim 17, characterized in that the system component (4) comprises a site (10) which is in contact with the spray-coating liquid on its way to the spray jet (14) and a site (54) which is not in contact with the spray-coating liquid on its way to the spray jet (14), and in that the cooling unit (50) is designed to feed the coolant (52) to the out-of-contact site (54) of the system component (4).

19. Spray system as claimed in claim 18, characterized in that the liquid atomizer is a rotary atomizing element (4) which is crossed by the coating liquid and in that the site (54) in contact with the coating liquid is an external, peripheral surface of the rotary atomizing element (4).

20. Spray system as claimed in one of claims 17 through 19, characterized in that the coolant is a cooled gas.
